(19) United States
(12) Patent Application Publication
(10) Pub. No.: US 2015/0217147 A1
(43) Pub. Date: Aug. 6, 2015

(54) RAIL LIFELINE FALL PROTECTION TURNTABLE ASSEMBLY

(71) Applicant: Capital Safety Group (Northern Europe) Limited, Redditch (GB)

(72) Inventors: Steven Eltringham, Redditch (GB); Robert Hirst, Stourbridge (GB)

(73) Assignee: Capital Safety Group (Northern Europe) Limited, Redditch (GB)

(21) Appl. No.: 14/174,224

(22) Filed: Feb. 6, 2014

(51) Int. Cl. A62B 35/00

(52) U.S. Cl. CPC A62B 35/0062; A62B 35/0068

(57) ABSTRACT

A rail lifeline fall protection turntable assembly is provided that includes a base member with rotating disk, a center rail, rail sections, stop members and corner members. The center rail is coupled to the rotating disk. Each rail section is coupled to the base member and is positioned to align with the center rail at a select rotational orientation of the rotating disk. The stop members are coupled to the rotating disk and are positioned to prevent a sliding shuttle from falling off one of the rail sections not aligned with the center rail. The corner members coupled to the base member and are positioned to prevent a sliding shuttle from falling off of the center rail when the center rail is not aligned with one of the rail sections.

### BACKGROUND

Workers who are required to perform tasks at heights are required to have the proper safety gear to protect against inadvertent fall events. A rail system is one type of fall protection system that is used where workers are required to move significant distances in completing tasks at a height. A rail system typically includes an elongated rail and shuttle that is slidably attached to the rail. The rail itself is attached to a support structure. The shuttle typically includes a connection portion that is designed to allow a lifeline to be coupled to the shuttle. The lifeline in turn is connected to a safety harness donned by a worker. It is desired to have an effective and safe method of switching between rails systems in a rail lifeline fall protection system.

For the reasons stated above and for other reasons stated below which will become apparent to those skilled in the art upon reading and understanding the present specification, there is a need in the art for an effective and efficient method of switching a shuttle between rail sections of a fall protection rail system.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a rail lifeline fall protection turntable assembly is provided that includes a base member, a rotating disk, a center rail, a plurality of rail sections, at least one first stop member and at least one second stop member. The rotating disk is pivotally coupled to the base member. The center rail is coupled to the rotating rail and is configured and arranged to hold a sliding shuttle that is coupled to a lifeline. The plurality of rail sections are configured and arranged to hold a sliding shuttle. Each rail section is coupled to the base member and is positioned to align with the center rail when the rotating disk is at a select rotational orientation in relation to the base. The at least one first stop member and the at least one second stop member is coupled to the rotating disk. The central rail is positioned between the at least one first stop member and the at least one second stop member. Moreover, the stop members are positioned to prevent a shuttle from coming off of one of the rail sections when the rail section is not aligned with the central rail.

In another embodiment, still another rail lifeline fall protection turntable assembly is provided. This rail lifeline fall protection turntable assembly includes a base member, a rotation disk, a center rail, first, second, third and fourth rail sections and corner members. The rotating disk is pivotally coupled to the base member. The center rail is coupled to the rotating disk and is configured and arranged to hold a sliding shuttle that is coupled to a lifeline. Each of the first, second and third rail sections are coupled to the base. The rotating disk is positioned between the first rail section and the second rail section. The first rail section is aligned with the second rail section. Moreover, the center rail is selectively aligned with the first and second rail sections when the rotating disk is at a select first rotational orientation in relation to the base member. In addition, the rotating disk is also positioned between the third rail section and the second rail section. The third rail section is aligned with the fourth rail section. Moreover, the center rail is selectively aligned with the third and fourth rail sections when the rotating disk is at a select second rotational orientation in relation to the base member. Each of the first, second, third and fourth rails are configured and arranged to hold a sliding shuttle. The corner member is coupled to the base between each of the first, second, third and fourth rail sections. Each corner member is positioned to prevent the shuttle from coming off of the center rail when the central rail is not aligned with at least one of the first, second, third and fourth rail sections.

In yet another embodiment, still another rail lifeline fall protection turntable assembly is provided. This rail lifeline fall protection turntable assembly includes, a base member, a rotation disk, a center rail, rail sections, at least one first stop member, at least one second stop member and corner members. The base member includes a central portion having a central circular recess and a plurality of spaced arm portions that extend out radially from the central portion. The rotating disk is received within the central circular recess. The rotating disk is configured and arranged to rotate 360 degrees within the central circular recess of the base member. The center rail is coupled to the rotating disk and is configured and arranged to hold a sliding shuttle. Each rail section is coupled to an associated arm portion of the base member. Each rail section is positioned to align with the center rail at a select rotational orientation of the rotating disk. The at least one first stop member and the second stop member are coupled to the rotating disk. The central rail is positioned between the at least one first stop member and the at least one second member. The at least one first and second stop members are further positioned to prevent a sliding shuttle from falling off rail sections not aligned with the center rail. Each corner member is coupled to the base member between each arm portion of the base member. Moreover, each corner member is positioned to prevent a sliding shuttle from falling off of the center rail when the center rail is not aligned with one of the rail sections.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a rail lifeline fall protection turntable assembly of an embodiment of the present application;

FIG. 2 is a side perspective view of the rail lifeline fall protection turntable assembly of FIG. 1 with a shuttle slidably attached to a rail system;

FIG. 3 is a partially unassembled side perspective view of the rail lifeline fall protection turntable assembly of FIG. 1;

FIG. 4 is a top view of the rail lifeline fall protection turntable assembly of FIG. 1;

FIG. 5 is a front view of the rail lifeline fall protection turntable assembly of FIG. 1; and

FIG. 6 is another side view of the rail lifeline fall protection turntable assembly of FIG. 1 with a central rail positioned to prevent passage of a shuttle on rail systems.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

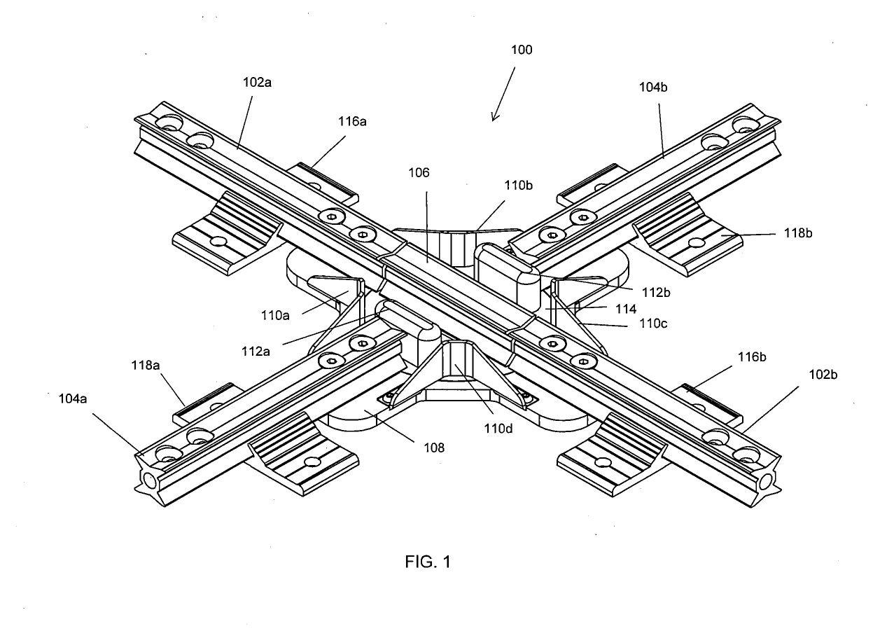

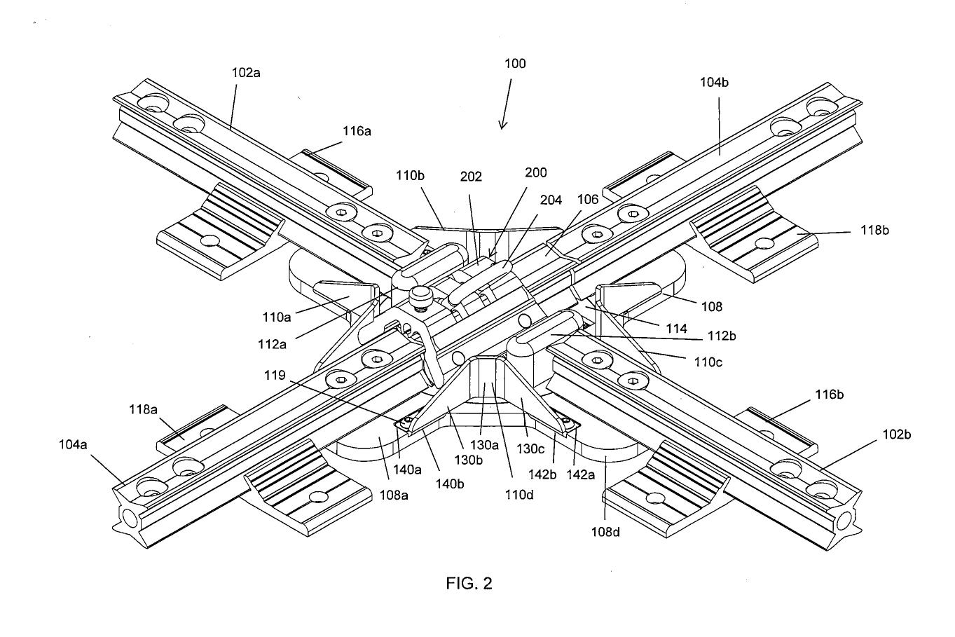

Embodiments of the present invention provide a rail lifeline fall protection turntable assembly that is designed to safely and efficient rout a shuttle (or carriage) between different track sections of a fall protection rail system. Referring to FIG. 1, a side perspective view of a rail lifeline fall protection turntable assembly 100 of one embodiment is illustrated. The rail lifeline fall protection turntable assembly 100 includes pairs of aligned rail sections. In particular, the embodiment of FIG. 1 includes a first rail section 102a and a second rail section 102b that form in part a first rail path and a third rail section 104a and fourth rail section 104b that form in part a second rail path. As illustrated, the second rail path in this embodiment is generally perpendicular to the first rail path. The safety line turntable assembly 100 also includes a center rail 106 that is selectively orientated in relation to a base member, as discussed below, to complete the first or second rail paths. In FIG. 1, the first rail path form by the center rail 106 and the first and second rail sections 102a and 102b is shown. Referring to the side perspective view of the rail lifeline fall protection turntable assembly 100 in FIG. 2, the central rail 106 is shown completing the second path with the third and fourth rail sections 104a and 104b. Further, in this illustration, a shuttle 200 is shown that is slidably engaged along the second path formed by the third rail section 104a, the center rail 106 and the fourth rail section 104b. The shuttle 200 is shown having a body 202 and a connecting eye 204. A lifeline (not shown) is attached to the connecting eye 204 of the shuttle 200.

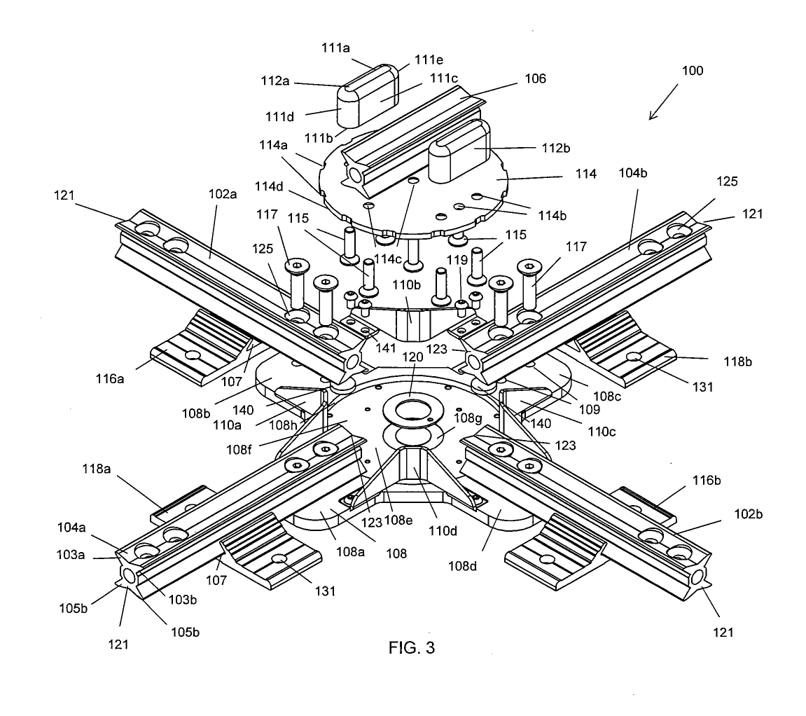

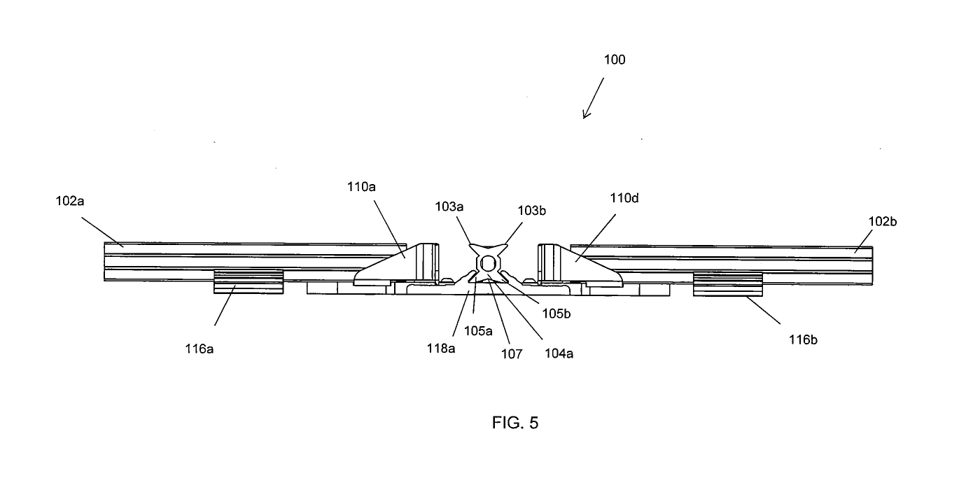

A partial unassembled side perspective view of the rail lifeline fall protection turntable assembly 100 is illustrated in FIG. 3. Each of the rail sections in this embodiment has a general X-shaped cross-sectional geometry that includes opposed upper ledges 103a and 103b and opposed lower ledges 105a and 105b as illustrated on rail section 104a as best seen in the side view of FIG. 5. The upper ledges 103a and 103b are used to hold the shuttle 200 on the rail section 104a as illustrated in FIG. 2. The lower ledges 105a and 105b are received in tracks 107 of respective rail mounting brackets, such as rail mounting bracket 118a, to mount a respective rail section 102a, 102b, 104a and 104b to the respective rail mounting bracket 116a, 116b, 118a and 118b as best shown in FIG. 3. The rail mounting brackets 116a, 116b, 118a and 118b are designed to be mounted on a support structure (not shown) via mounting apertures 131. As illustrated in FIG. 3, the first rail section 102a is held in a track 107 of rail mounting bracket 116a, the second rail section 102b is held in a track 107 of rail mounting bracket 116b, as discussed above, the third rail section 104a is held in a track 107 of rail mounting bracket 118a and the fourth rail section 104b is held in a track 107 of the rail mounting bracket 118b. Each of the rail sections 102a, 102b, 104a and 104b has a first end 121 that is designed to be aligned with and attached to an associated rail system (not shown) and a second end 123. Each rail section 102a, 102b and 104a and 104b is coupled to a base member 108 proximate the rail section's second end 123 via fasteners 117 passing through rail apertures 125.

The base member 108 has a central portion 108e with a central circular recess 108f and a central disk shaped recess 108g that is centrally located within the central circular recess 108f. The base 108 further has arm portions that extend from the central portion 108e. In particular, in this embodiment, four arm portions 108a, 108b, 108c and 108d extend outward from the central portion 108e. As discussed above, the respective rail sections 102a, 102b, 104a and 104b are coupled to the arm portions 108a, 108b, 108c and 108d of the base member 108 via fasteners 117 passing through rail apertures 125 and arm apertures 109. Moreover, as also discussed above, the first rail section 102a is aligned with the second rail section 102b to form the partial first rail path and the third rail section 104a is aligned with the fourth rail section 104b to form the partial second rail path.

The center rail 106 is couple to a rotating disk 114 via fasteners 115 passing through apertures 114c in the rotating disk 114. The center rail 106 is positioned to bisect the rotating disk 114 to selectively align the center rail 106 with the first and second rail sections 102a and 102b or the third and fourth rail sections 104a and 104b. The rotating disk 114 is received within the central circular recess 108f and is allowed to rotate 360 degrees within the circular recess 108f. As best illustrated in FIG. 3, the rotating disk 114 includes a plurality of holding grooves 114a that are spaced along a perimeter 114d of the rotating disk 114. Coupled along a perimeter 108h of the central circular recess 108f is a plurality of slip pads 140. The slip pads 140 are positioned so a portion of each slip pad 140 that extends over the central circular recess 108f is selectively received in one of the holding grooves 114a in the rotating disk 114. This arrangement selectively holds the rotating disk 114 and central rail 106 in a static position relative to the base member 108 until a rotating force is applied to the central rail 106. In one embodiment, the holding groove and slip pad configuration provide holding positions of the central rail 106 that are in 90 degree increments relative to the base 108. In one embodiment, the holding groove and slip pad configuration provide holding positions of the central rail that are in 45 degree increments relative to the base 108. Received within the disk shaped recess 108g is a bearing washer 120 upon which the rotating disk 114 rotates.

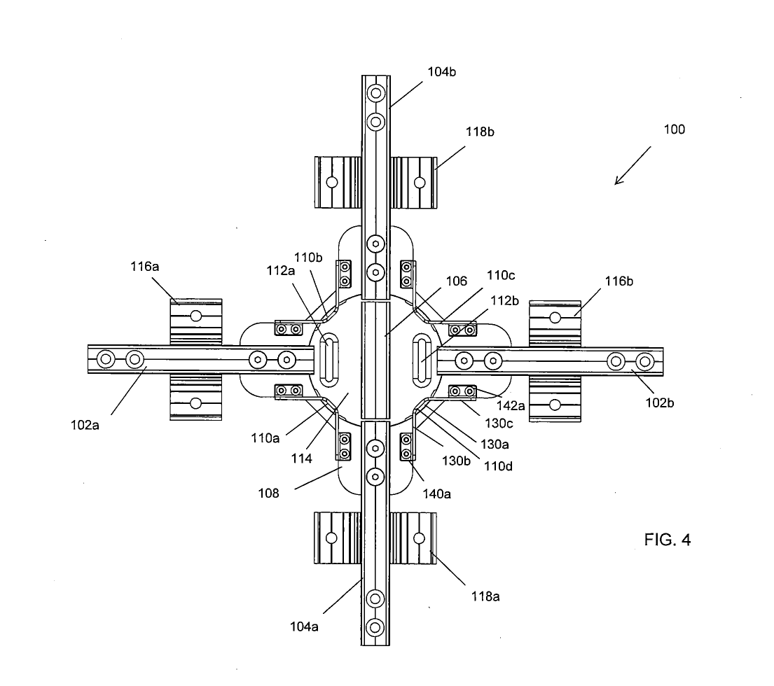

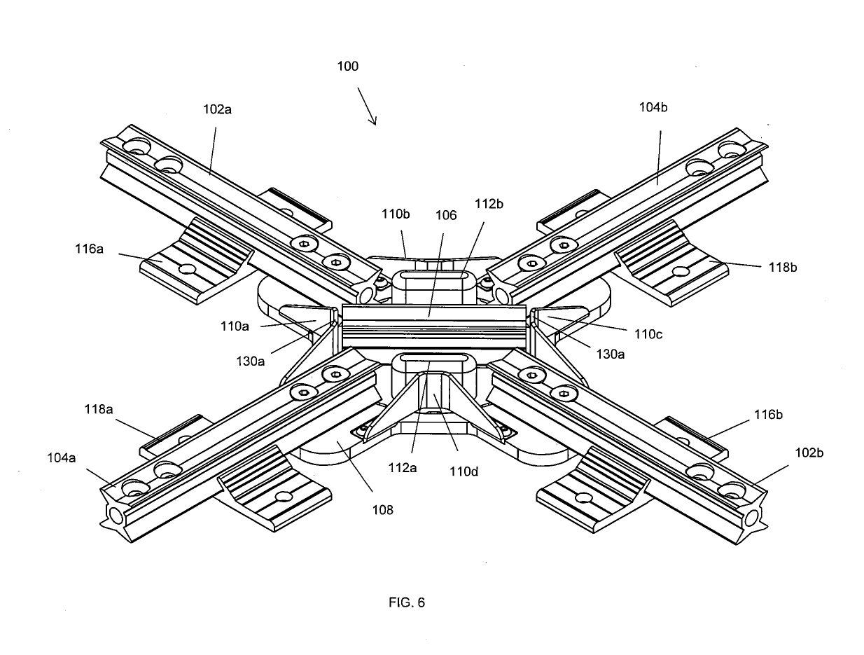

Embodiments of the rail lifeline fall protection turntable assembly 100 include corner members 110a, 110b, 110c and 110d that are coupled to the base 108. The corner members 110a, 110b, 110c and 110d are used to prevent a shuttle that is slideably engaged on the central rail 106 from falling off an end of the central rail 106 when the central rail 106 is not aligned with one of the first and second rail paths as best illustrated in FIG. 6. Also, the corner members 110a, 110b, 110c and 110d, in one embodiment, are used to hold the rotating disk 114 within the central circular recess 108f of the base member 108 as best illustrated in the top view of FIG. 4. Referring to the top view of the safety line turntable assembly 100 in FIG. 4 and the side perspective view of FIG. 2, the elements of each corner member is discussed. In particular, the aspects of each corner member are illustrated in respect to corner member 110d. Each corner member includes a mid-portion 130a and first and second side portions 130b and 130c. The first and second side portions 130b and 130c extend out in opposite directions from the mid-portion 130a at select angles. In the embodiment shown in FIG. 4, the first and second side portions 130b and 130c extend out from themed-portion 130a in a generally perpendicular fashion.

Extending from a surface of each side portion 130b and 130c is a connecting tab portion 140a and 142a that are used to attach the respective side portions 130b and 130c to respective arm portions 108a and 108d of the base member 108. For example, referring to FIG. 2, connecting tab portion 140a extending perpendicular from a lower surface of the first side portion 130b is coupled to the first arm portion 108a of the base member 108 via fasteners 119 and connecting tab portion 142a extending perpendicular from a lower surface of the second side portion 130c is coupled to the fourth arm portion 108d of the base 108 via fasteners 119. The fasteners 119 pass through tab apertures 141 (shown in FIG. 3) in coupling the connection tab portions 140a and 142a to their respective arm portion 108a and 108d of the base member 108. Also illustrated in FIG. 2, are holding tabs 140b and 142b that extend from bottom edges of the first and second side portions 130b and 130c. The respective holding tabs 140b and 142b help retain a corner member in position relative to the base member 108 when the corner member is attached to respective arm portions 108a, 108b, 108c and 108d of the base member 108. For example, holding tab 140b is positioned to abut an inner surface of the first arm portion 108a of the base member 108 and holding tab 142b is positioned to abut an inner surface of the fourth arm portion 108d of the base member 108 when corner member 110d is coupled to the base member 108. As best illustrated in FIG. 4, when the corner members 110a, 110b, 110c and 110d are coupled to the base member, the mid-portion 130a of each corner member 110a, 110b, 110c and 110d are positioned over the rotating disk 114 to retain the rotating disk 114 in the central circular recess 108f of the base 108 as discussed above. In the embodiment illustrated in FIG. 2, each of the side portions, 130b and 130c taper down in height from the mid-portions 130a. Hence, in the embodiment shown, the side portions 130b and 130c are generally triangle shaped. Moreover, in the embodiment illustrated, the mid-portion 130a of each corner member 110a, 110b, 110c and 110d are positioned to be perpendicular to a longitudinal axis of the center rail 106 when the central rail 106 is aligned with respective corner members 110a, 110b, 110c and 110d. For example, referring to FIG. 6, the rotating disk 14 is turned so the central rail 106 is aligned with the corner members 110a and 110c. This configuration may be used when it is desired that he shuttle remain on the central rail 106. Moreover, in this configuration, the mid-portion 130a of the corner members 110a and 110c prevent the shuttle from coming off ends of the central rail 106.

The rail lifeline fall protection turntable assembly 100 further includes stop members 112a and 112b. Referring to FIG. 3, the stop members 112a and 112b are mounted on the rotating disk 114 via fasteners 115 that extend through attaching apertures 114b of the rotating disk 114 and into the stop members 112a and 112b. In one embodiment, the stop members include treaded bores (not shown) in which the fasteners 115 engage to couple the stop members 112a and 112b to the rotating disk 114. The stop members 112a and 112b are positioned on opposite sides of the center rail 106 and in one embodiment they are both positioned in a parallel fashion in relation to the center rail 106. Each stop member 112a and 112b, in the embodiment shown, includes a top 111a and a bottom 111b. The bottom 111b is flat to engage a surface of the rotating disk 114 and the top 111a is at least partially rounded along edges to prevent items, such as lifelines, from getting caught during use. Each stop member 112a and 112b further includes an elongated mid-portion 111c and rounded end portions 111d and 111e. The stop members 112a and 112b are used to block ends of rail sections 102a, 102b, 104a and 104b when the central rail 106 is not aligned with the respective rail sections 102a and 102b or 104a and 104b to prevent a shuttle from inadvertently falling off one of the rail sections 102a, 102b, 104a and 104b. For example referring to the illustration of the safety line turntable assembly of FIGS. 1 and 4, the rotating disk 114 has been rotated so the center rail 106 aligns with rail sections 102a and 102b to form the first rail path. In this configuration, the stop members 112a and 112b will prevent a shuttle (not shown in these Figures) that is slidably engaged with either rail section 104a or 104b from sliding off of the respective rail section 104a and 104b. Moreover, referring to FIG. 2, rotating disk 114 has been rotated so the center rail 106 aligns with rail sections 104a and 104b. In this configuration, the stop members 112a and 112b will prevent a shuttle (not shown in this Figure) that is slidably engaged with either rail section 102a or 102b from sliding off of the respective rail 102a and 102b. Moreover, in one embodiment, the rounded end portions 111d and 111e of the stop members 112a and 112b prevent shuttles from sliding off the rail sections 102a, 102b, 104a and 104b when the center rail 106 is not aligned with either the rail sections 102a and 102b or 104a and 104b as illustrated in FIG. 6. Hence, with this embodiment, the rail lifeline fall protection turntable assembly 100 prevents shuttles from inadvertently falling of ends of one of the rail sections 102a, 102b, 104a and 104b no matter the position of the center rail 106 or whether the center rail 106 and rotating disk 114 are moving.

In use, a worker working at a height attaches a safety line to the connecting eye 204 of the shuttle 200. When the worker reaches the rail lifeline fall protection turntable assembly 100, the worker grasps the center rail 106 and turns the center rail 106 and disk 114 until the center rail 106 aligns with the then current rail section the shuttle is slidably engaged. If the worker desires to change direction, the worker moves the shuttle onto the center rail 106. Once the shuttle is slidably engaged with the center rail 106, the center rail 106 is then rotated to align the center rail 106 to rail sections that define a desired rail path. The configuration including the corner members 110a, 110b, 110c and 110d prevent the shuttle from falling off ends of the center rail 106 while rotating. Once the center rail 106 is aligned with the desired rail sections, the user can slide the shuttle along the desired rail path. As discussed above, the slip pads 140 in the spaced grooves 114a in the rotating disk 114 hold the rotating disk 114 in a static position in relation to the base member 108 until a force (turn force applied to the center rail 106) is applied.

In embodiments the configuration and materials used allow the safety line turntable assembly 100 to expand/contract due to temperature changes without affecting the function of the rail lifeline fall protection turntable assembly 100. In one embodiment, 316 stainless steel and high strength metal alloy (such as 6010) aluminum) is used to construct the safety line turntable assembly.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A rail lifeline fall protection turntable assembly comprising:
a base member;
a rotating disk pivotally coupled to the base member;
a center rail coupled to the rotating rail, the central rail configured and arranged to hold a sliding shuttle that is coupled to a lifeline;
a plurality of rail sections configured and arranged to hold a sliding shuttle, each rail section coupled to the base member and positioned to align with the center rail when the rotating disk is at a select rotational orientation in relation to the base;
at least one first stop member coupled to the rotating disk; and
at least one second stop member coupled to the rotating disk, the central rail positioned between the at least one first stop member and the at least one second stop member, wherein the stop members are positioned to prevent a shuttle from coming off of one of the rail sections when the rail section is not aligned with the central rail.

2. The rail lifeline fall protection turntable assembly of claim 1, wherein each of the at least one first and second stop members further comprises:
a top that is at least partially rounded; and
a bottom that is flat, the bottom coupled to the rotating disk.

3. The rail lifeline fall protection turntable assembly of claim 2, each of the at least one first and second stop members further comprising;
an elongated mid-portion positioned between rounded end portions.

4. The rail lifeline fall protection turntable assembly of claim 1, wherein each of the at least one first and second stop members are parallel to the center rail.

5. The rail lifeline fall protection turntable assembly of claim 1, further comprising:
a corner member coupled to the base member between adjacent rail sections, each corner member configured and arranged to prevent the shuttle from coming off of the center rail when the central rail is not aligned with one of the rail sections.

6. The rail lifeline fall protection turntable assembly of claim 5, each corner member further comprising:
a mid-portion;
a first side portion extending from a first side of the mid-portion at a select angle; and
a second side portion extending from a second side of the mid-portion at a select angle.

7. The rail lifeline fall protection turntable assembly of claim 6, wherein each of the first side portion and the second side portion has a height that tapers down from the mid-portion.

8. The rail lifeline fall protection turntable assembly of claim 6, wherein the first and second side portions are positioned generally perpendicular to each other.

9. The rail lifeline fall protection turntable assembly of claim 6, further comprising:
the base member having a central portion and a plurality of spaced arm portions that extend from the central portion, the central portion of the base member having a central circular recess configured and arranged to receive the rotating disk; and
the mid portion of the corner members positioned over the central circular recess to retain the rotating disk within the central circular recess.

10. The rail lifeline fall protection turntable assembly of claim 9, further comprising:
the first side portion and the second side portion of each corner member having a holding tab that is configured and arranged to be couple to restive arm portions of the base member.

11. The rail lifeline fall protection turntable assembly of claim 1, further comprising:
the rotating disk having a perimeter, a plurality of spaced holding grooves formed in the perimeter of the rotating disk; and
at least one slip pad coupled to the base member, the at least one slip pad positioned so at least a part of the at least one slip pad is received within one of the holding grooves when the rotating disk is rotated so the slip pad is aligned with a holding groove, the rotating disk configured and arranged to be held in a static position in relation to the base member when the at least one slip pad is received within a holding groove until a select rotational force is applied to the rotating disk.

12. A rail lifeline fall protection turntable assembly comprising:
a base member;
a rotating disk pivotally coupled to the base member;
a center rail coupled to the rotating rail, the central rail configured and arranged to hold a sliding shuttle that is coupled to a lifeline;
a first rail section couple to the base;
a second rail section coupled to the base, the rotating disk positioned between the first rail section and the second rail section, the first rail section being aligned with the second rail section, wherein the center rail is selectively aligned with the first and second rail sections when the rotating disk is at a select first rotational orientation in relation to the base member;
a third rail section coupled to the base;
a fourth rail section coupled to the base, the rotating disk positioned between the third rail section and the second rail section, the third rail section being aligned with the fourth rail section, wherein the center rail is selectively aligned with the third and fourth rail sections when the rotating disk is at a select second rotational orientation in relation to the base member, further where in the first, second, third and fourth rails are configured and arranged to hold a sliding shuttle; and
a corner member coupled to the base between each of the first, second, third and fourth rail sections, each corner member positioned to prevent the shuttle from coming off of the center rail when the central rail is not aligned with at least one of the first, second, third and fourth rail sections.

13. The rail lifeline fall protection turntable assembly of claim 12, each corner member further comprising:
a mid-portion;
a first side portion extending from a first side of the mid-portion at a select angle; and
a second side portion extending from a second side of the mid-portion at a select angle.

14. The rail lifeline fall protection turntable assembly of claim 13, wherein each of the first side portion and the second side portion has a height that tapers down from the mid-portion.

15. The rail lifeline fall protection turntable assembly of claim 13, further comprising:
the base member having a central portion and a plurality of spaced arm portions that extend from the central portion, the central portion of the base member having a central circular recess configured and arranged to receive the rotating disk; and
the mid portion of the corner members positioned over the central circular recess to retain the rotating disk within the central circular recess.

16. The rail lifeline fall protection turntable assembly of claim 12, further comprising:
the rotating disk having a perimeter, a plurality of spaced holding grooves formed in the perimeter; and
at least one slip pad coupled to the base member, the at least one slip pad positioned so at least a part of the at least one slip pad is received within one of the holding grooves when the rotating disk is rotated so the slip pad is aligned with a holding groove, the rotating disk being held in a static position in relation to the base member when the at least one slip pad is received within a holding groove until a select rotational force is applied to the rotating disk.

17. A rail lifeline fall protection turntable assembly comprising:
a base member including a central portion having a central circular recess and a plurality of spaced arm portions radially extending out from the central portion;
a rotating disk received within the central circular recess of the base member, the rotating disk configured and arranged to rotate 360 degrees within the central circular recess of the base member;
a center rail coupled to the rotating disk, the center rail configured and arranged to hold a sliding shuttle;
a rail section for each arm portion of the base member, each rail section coupled to an associated arm portion of the base member, each rail section positioned to align with the center rail at a select rotational orientation of the rotating disk;
at least one first stop member coupled to the rotating disk;
at least one second stop member coupled to the rotating disk, the central rail being positioned between the at least one first stop member and the at least one second member, the at least one first and second stop members further positioned to prevent a sliding shuttle from falling off rail sections not aligned with the center rail; and
a corner member coupled to the base member between each arm portion of the base member, each corner member positioned to prevent a sliding shuttle from falling off of the center rail when the center rail is not aligned with one of the rail sections.

18. The rail lifeline fall protection turntable assembly of claim 17, each corner member further comprising:
a mid-portion, the mid portion of the corner members positioned over the central circular recess to retain the rotating disk within the central circular recess;
a first side portion extending from a first side of the mid-portion at a select angle; and
a second side portion extending from a second side of the mid-portion at a select angle, wherein each of the first side portion and the second side portion has a height that tapers down from the mid-portion.

19. The rail lifeline fall protection turntable assembly of claim 17, wherein each of the at least one first and second stop members further comprises:
a top that is at least partially rounded;
a bottom that is flat, the bottom coupled to the rotating disk; and
an elongated mid-portion positioned between rounded end portions.

20. The rail lifeline fall protection turntable assembly of claim 17, further comprising:
the rotating disk having a perimeter, a plurality of spaced holding grooves formed in the perimeter; and
at least one slip pad coupled to the base member, the at least one slip pad positioned so at least a part of the at least one slip pad is received within one of the holding grooves when the rotating disk is rotated so the slip pad is aligned with a holding groove, the rotating disk being held in a static position in relation to the base member when the at least one slip pad is received within a holding groove.
